(19) United States
(12) Patent Application Publication
(10) Pub. No.: US 2011/0047106 A1
(43) Pub. Date: Feb. 24, 2011

(54) CONSTUCTION OF TARGETED ADAPTIVE DESIGNS AND MAXIMUM LIKELIHOOD LEARNING FOR ADAPTIVE DESIGNS

(75) Inventor: Mark van der Laan, Orinda, CA (US)

Correspondence Address: Trellis Intellectual Property Law Group, PC, 1900 EMBARCADERO ROAD, SUITE 109, PALO ALTO, CA, 94303, US

(73) Assignee: THE REGENTS OF THE UNIVERSITY OF CALIFORNIA, Oakland, CA (US)

(21) Appl. No.: 12/918,798

(22) PCT Filed: Feb. 20, 2009
(86) PCT No.: PCT/US09/34724

§ 371 Date: Nov. 12, 2010

Related U.S. Application Data
(60) Provisional application No. 61/030,923, filed on Feb. 22, 2008.

(51) Int. Cl. G06F 15/18

(52) U.S. Cl. 706/13

(57) ABSTRACT

In one embodiment, a method for targeted adaptive design processing is provided. The method comprises: determining data for a first stage of an adaptive design, each stage of the adaptive design being a set of experiments that are adapted based on a design mechanism, the data for a stage including data for the set of experiments for that stage; determining an estimator based on the data for the first stage; and analyzing the data using the estimator to adapt the design mechanism for a next stage of the adaptive design, the adaptive design mechanisms sign mechanism being considered more optimal to yield data for estimating a target parameter; and outputting the design mechanism for use in a second stage of the experiment. The method further comprises determining a second estimator for the adaptive design usable to estimate the target parameter of the adaptive design based on the analysis.

### CROSS REFERENCES TO RELATED APPLICATIONS

This application claims priority from U.S. Provisional Patent Application Ser. No. 61/030,923, entitled CONSTRUCTION OF TARGETED ADAPTIVE DESIGNS AND ESTIMATOR LEARNING FOR ADAPTIVE DESIGNS, filed on Feb. 22, 2008, which is hereby incorporated by reference as if set forth in full in this application for all purposes.

### BACKGROUND

Particular embodiments generally relate to analysis and construction of adaptive designs and estimators based on the adaptive designs.

Each experiment is indexed by a data generating distribution generating the data on the experimental unit for that experiment. A parameter of interest/target parameter/target feature is a certain feature of these data generating distributions in which it is desired to estimate from the data generated by the sequence of experiments.

Each experiment has a design mechanism, which is a conditional probability distribution that is used to generate/draw the design settings for that experiment, where this probability distribution is conditional on characteristics of the experimental unit on which data is collected. The design mechanism may be a rule that tells a user how to deterministically assign the design settings in response to some characteristics of the experimental unit, or, more general, how to assign probabilities to the design settings in response to some characteristics of the experimental unit, which can then be used to randomize the unit to one of the design settings. In fixed designs, this design mechanism is the same for all experiments, which still allows that the design settings are selected in response to observed characteristics of the experimental unit.

### SUMMARY

In one embodiment, a method for targeted adaptive design processing is provided. The method comprises: determining data for a first stage of an adaptive design, each stage of the adaptive design being a set of experiments that are adapted based on a design mechanism, the data for a stage including data for the set of experiments for that stage; determining an estimator based on the data for the first stage; and analyzing the data using the estimator to adapt the design mechanism for a next stage of the adaptive design, the adaptive design mechanism being considered more optimal to yield data for estimating a target parameter; and outputting the design mechanism for use in a second stage of the experiment. The method further comprises determining a second estimator for the adaptive design usable to estimate the target parameter of the adaptive design based on the analysis.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts a simplified system according to one embodiment.

FIG. 2 depicts a simplified flowchart of a method for determining design settings according to one embodiment.

FIG. 3 depicts a simplified flowchart of a method for determining data adaptive estimator according to one embodiment.

FIG. 4 depicts a simplified flowchart 400 of a method for obtaining an adaptive design estimator according to one embodiment.

### DETAILED DESCRIPTION OF EMBODIMENTS

Particular embodiments construct an adaptive design (i.e., a way of determining a design mechanism for an experiment in response to data collected on previous experiments), and, given the adaptive design, particular embodiments estimate a scientific parameter of interest and provide valid assessment of the uncertainty in the estimates based on data generated by the adaptive designs. The first component provides a method, based on influence curves, for constructing targeted adaptive designs optimized with respect to one or more parameters of interest of the data generating distribution. The second component provides a method for estimation of a parameter of interest in possibly high dimensional models, such as semiparametric models, thereby avoiding the need to assume parametric models that rely on invalid assumptions, based on data generated by the adaptive designs, and corresponding statistical inference.

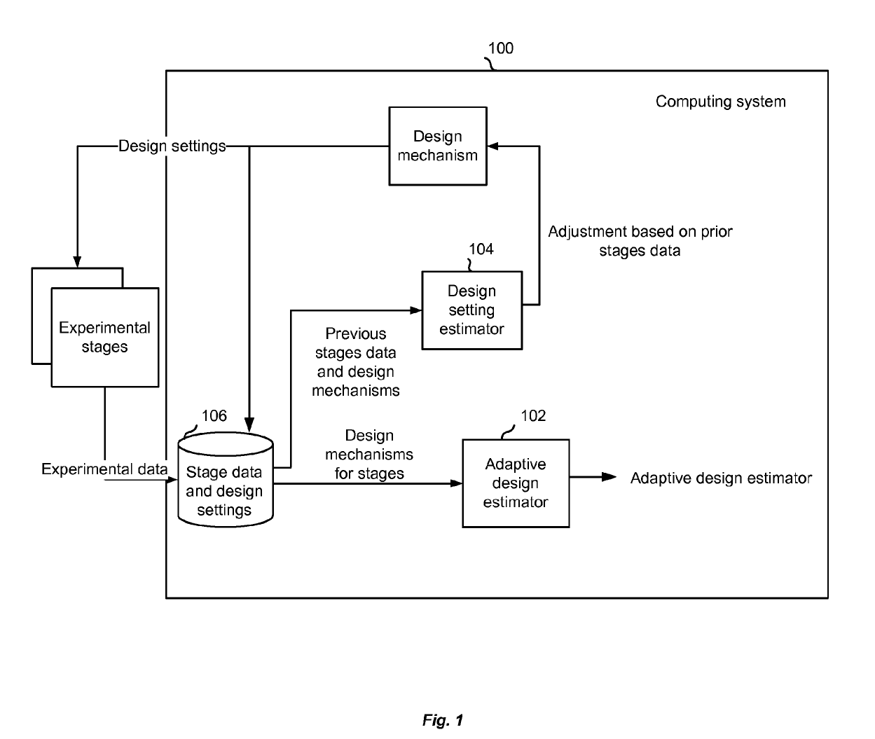

FIG. 1 depicts a simplified computing system 100 according to one embodiment. An experiment or other study may be performed in stages. The experiment may be any situation where measurements can be taken. Each experiment is indexed by a data generating distribution generating the data on an experimental unit for that experiment. A parameter of interest/target parameter/target feature is a certain feature of these data generating distributions in which it is desired to estimate from the data generated by the sequence of experiments.

The experimental unit may be a subject to the experiment, such as a patient, in which the experiment or study is performed and measurements are taken. The target parameter (also referred to as a parameter of interest or target feature) is what a user desires to estimate. For example, an adaptive design estimator 102 is configured to estimate the target parameter based on the data generated by the adaptive designs. Before the adaptive design estimator 102 of the target feature is determined, the experiment is run in stages to collect data, which can be used to determine adaptive design estimator 102.

Estimator 102 is determined based on a series of experiments. Each experiment has a design mechanism, which is a conditional probability distribution that is used to generate/draw the design settings for that experiment, where this probability distribution is conditional on characteristics of the experimental unit on which data is collected. The conditional probability distribution provides probabilities that are assigned to particular design settings, such as a high dose of medicine is assigned a probability of 80% to be assigned to an experimental unit. Randomization of the design occurs in that around 80% of the time, an experimental unit is assigned the high dose and 20% the low dose.

The design mechanism may be a rule that is used to assign the design settings in response to some characteristics of the experimental unit. In order to answer scientific questions of interest, a user often carries out an ordered (in time) sequence of experiments generating the appropriate data over time. The design of each experiment involving randomly sampling an experimental unit requires making various decisions such as 1) What variables to measure on the randomly sampled experimental unit?, 2) How regularly to monitor the unit, and for how long?, 3) How to randomly assign a treatment or drug-dose to the unit?, and 4) what type of experimental unit to sample, among others. That is, the design of each experiment involves selecting a mechanism (probabilistic, thereby including deterministic rules) used to generate the design settings, such as a treatment mechanism/monitoring mechanism/missingness/censoring mechanism/subgroup-selection mechanism, where these mechanisms represent formally defined conditional probability distributions of one of these actions (i.e., assignment of treatment/monitoring indicator/missingness indicators/right censoring indicators/subgroup membership), given observed characteristics of the experimental unit. This collective set of these mechanisms for an experiment is called the design mechanism or design for that experiment. In current practice, the choice of these design mechanisms are typically made a priori and a user typically selects the same choice for all experiments. It is common that during the course of the ordered sequence of experiments the observed data suggests that the chosen design is ineffective in answering the scientific question of interest, or is dissatisfying from other perspectives. Thus, particular embodiments adaptively adjust the design mechanism, and thereby the settings, to select a better design (i.e., choice of mechanisms).

Particular embodiments learn an a priori defined unknown optimal choice for design mechanism (i.e., controlled components) of the design of the next experiment stage based on the data collected in the previously initiated experiments, and thereby adjust/adapt the choice of the design mechanism (and thereby settings) of the design of future experiments during the course of the study.

A design setting estimator 104 of the unknown optimal design mechanism is used to analyze data from prior stages (each stage representing a set of one or more experiments) of the adaptive design. The adaptive design may be stages of any data producing study that is controlled by the design settings. For example, different stages may have had different design mechanisms generating the design settings for the experiments in that stage. Once the designs settings in an experiment are generated, they can be output or displayed. Then, all the data on the experimental unit for that experiment is observed and determined based on the design settings. As different stages of the adaptive design are performed, the design mechanisms used to generate the design settings may be adjusted between stages.

Design setting estimator 104 may be used to generate the design mechanism (and thus also its design settings in response to the observed characteristics of the experimental units) for a next stage of experiments of the adaptive design. Design setting estimator 104 may analyze the data measured for previous stages and the design mechanisms used in previous stages to determine the design mechanism for the next stage. In one embodiment, design setting estimator 104 may be based on a targeted maximum likelihood estimator in a semi-parametric model. Other estimators and types of models may be appreciated.

In one example, a first stage of an adaptive design may include measuring data on 100 patients representing the experimental units of the first 100 experiments. Based on the observed data on these 100 patients, the causal effect of a drug on a clinical outcome may be estimated. The design settings for these 100 patients might include the drug choice, the dose of the drug, the amount of time on the drug, among others, and the settings for a particular patient might have been based on characteristics of that patient, thus allowing for different settings for different patients. The design settings thus set parameters for the experiment to be run. The design settings may be generated based on a conditional probability given observed characteristics of the experimental unit/patient. The data on these 100 patients in the first stage may now be analyzed to determine if the settings were optimal or could be improved upon for future patients enrolled in the trial. Making the choice of settings for one patient depends on the data of previously recruited patients makes the design an adaptive design, while if the settings of the patient only depend on observed characteristics of the patient itself, then it is still called a fixed design.

A different set of design mechanisms for a second stage of experiments are determined based on the outcome data for the first stage of experiments. A next set of experiments is then run again with a set of experimental units, such as a different set (e.g., another 100 patients), and this new way of setting the design settings (i.e., the new design mechanisms) for each patient possibly in response to the characteristics of the patients is now used. Outcome data for the second stage of experiments is determined, stored in data storage 106, and can be analyzed. The data for all previous stages may be analyzed to determine new design mechanisms (and thereby the manner to set the design settings) for a next stage. This is an adaptive design that attempts to alter the settings to achieve an optimal outcome (i.e., set of data) for the sequence of experiments. For example, it might attempt to collect maximal information for estimating a target feature of interest.

Particular embodiments attempt to predict the design mechanisms (and thereby the manner in which the design settings are set in response to characteristics of the experimental unit selected) that should be used for a next stage based on previous stages data. As discussed above, design setting estimator 104 may be used to predict settings that may be considered optimal.

After performing the stages for the experiment, different data for different stages is determined. Each of the stages including different settings in which a particular design setting may have been set in response to the data collected on data collected in other experiments. This dependence between the data between different experiments may result in biased estimates and thereby makes analyzing the data as a whole difficult. Accordingly, particular embodiments generate adaptive design estimator 102 based on an analysis of the data determined for different stages. Adaptive design estimator 102 may be used to predict an outcome for a new experimental unit based on characteristics of this experimental unit, or it may estimate the causal effect of an intervention on an outcome.

Adaptive design estimator 102 may receive as input characteristics for a new experimental unit. The target parameter may be what a user wants to estimate, such as the optimal treatment to assign a patient with certain characteristics. The characteristics may be measured for the patient. These characteristics are input in adaptive design estimator 102 to obtain the optimal treatment for the patient. As another example, adaptive design estimator 102 may estimate the average effect of a certain dosage of medicine on a clinical outcome. Also, the adaptive design estimator may be used to set policy for how an input variable should be used in practice (e.g., how a drug should be prescribed in practice). In another application, the adaptive design estimator may build a predictor of response to treatment based on individual characteristics. In that case, adaptive design estimator may be used for a new patient to predict the response to treatment (e.g., chemo).

Adaptive design estimator 102 is determined based on the data generated by the adaptive design. Because the design was adapted, the estimator used takes into account how, for each experiment, the design settings were adjusted in response to characteristics of the experimental unit and the data generated by previous experiments. To account for the adaptive design, one embodiment maps a fixed design estimating function (and thus corresponding estimator) into an adaptive design (e.g., martingale) estimating function. In one embodiment, particular embodiments determine how to map a fixed design targeted maximum likelihood estimator into an adaptive design targeted maximum likelihood estimator. In this way, available estimators for fixed designs are used to generate possible adaptive design estimators. Adaptive design estimator 102 may determine the mappings based on the design mechanisms that where used for each experiment to generate the design settings, and a choice of fixed design mechanism used in the fixed design estimator. For example, weightings for each experimental unit are determined based on the design settings and the design mechanisms that were used to generate these design settings. Each experimental unit is weighted by a ratio of a data based common estimate of a design mechanism used in the fixed design estimator (such as the last design mechanism used in the last experiment of the sequence of experiments to be analyzed) and the unit specific design mechanism (i.e., the mechanism that was used to generate the design settings used for that particular unit), both evaluated at the design settings used in the experiment.

In one example, the weights are determined based on the probability a particular design setting is assigned during the experiment, where this particular design setting is the actual setting as used in the experiment. Every observation may be inverse weighted by such a randomization probability. This randomization probability is determined by the design mechanism used in that experiment and the design settings used in that experiment. For example, if during the experiment, for the particular experimental unit, the randomization probability for receiving treatment was set at 80%, then the inverse weight of the unit may be the reciprocal of 0.8 if the unit received the treatment, and it may be the reciprocal of 0.2 if the unit received the control. For example, if the probability for assigning a high dose of medicine for a sick patient was determined to be 80% during the experiment, and the patient did indeed receive the high dose, then the reciprocal of 0.8 is assigned as inverse weight in the mapping.

Assigning the inverse weight corrects for the bias that may be caused by the randomization probability being dependent on measured characteristics of the experimental unit and the data collected on experimental units in previous experiments. An estimating function for a fixed design for estimating a certain target feature is a function of the data on the experimental unit, and possible target feature value, and it may be indexed by unknown quantities/nuisance parameters of the data generating distribution of the experiment, including the design mechanism. In one embodiment, the fixed design mechanism in this estimating function is replaced by the design setting estimator at the last experiment, and the whole resulting estimating function for the experimental unit is weighted by the above mentioned ratio of design setting estimator, as obtained at the last experiment, and the actual design mechanism used in this experiment. In addition, the nuisance parameters are appropriately estimated based on the adaptive design data. This newly formed weighted estimating function now results in an estimating equation for the target feature as usual by setting its empirical average across all experiments equal to zero and solving for the target feature of interest. The latter solution is now the resulting estimator of the target feature based on the adaptive design data

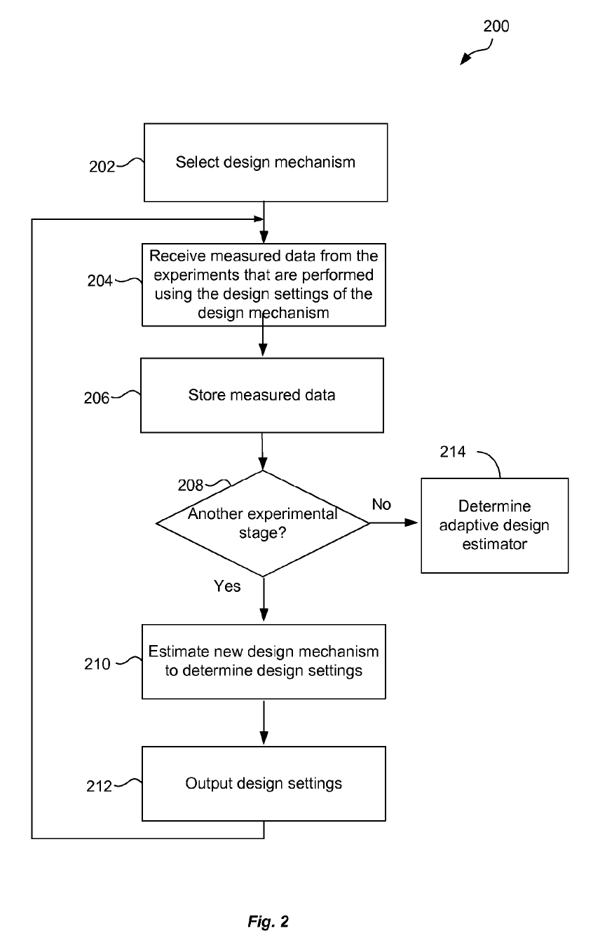

FIG. 2 depicts a simplified flowchart 200 of a method for determining design settings according to one embodiment. In step 202, a design mechanism is selected. The design mechanism may be a conditional distribution of data. The design mechanism can be used to generate design settings for the experimental unit. For example, the design mechanism yields randomization probabilities for assigning treatment versus control. For example, the design mechanism may set the probability for treatment at 80% and the probability for receiving control at 20%, based on the characteristics of the experimental unit and the data collected in previous experiments. These randomization probabilities may be different for an experimental unit with different characteristics. These randomization probabilities may also be different due to its dependence on all the data in the past experiments. Thus these randomization probabilities may depend on both the characteristics of the experimental unit as well as the data collected in previous experiments.

Step 204 receives measured data from the experiments that are performed using the design settings generated by the design mechanism. For example, in an experiment stage, one or more experiments may be performed with experimental units. A full set of measurements on the experimental unit may be measured based on a treatment that is assigned. The treatment that is assigned may be determined based on the design settings that were assigned to the experimental unit. The treatment may represent just one of the design settings for the experimental unit or it may represent the only design setting for the experiment. Different treatment assignments may result in different outcomes for the patient and the outcomes for the treatment the patient actually received may be measured. The data may then be input into design settings estimator 104. In step 206, the measured data is stored in a data storage 106.

In step 208, it is determined if another experimental stage should be performed. If not, the process ends and it can proceed to determining adaptive design estimator 102.

If another stage is to be performed, step 210 estimates a new design mechanism to be used to generate design settings for next stage of experiments. As discussed above, design setting estimator 104 may determine a different design mechanism (and thus settings) based on the prior stages' data.

In step 212, the design mechanism for next stages is output, which includes formulas for randomization probabilities for any of the design settings for any given possible experimental unit. For example, the design mechanism may be displayed to a user such that the user can implement the design settings in a new experimental stage. Also, the design mechanism settings may be output to a computing device that can compute the treatment to be assigned based on the conditional probability distribution given characteristics of experimental unit. For example, the design settings may be generated by the design mechanism and treatment assignments may be output. For example, for certain experimental units, different treatments may be assigned. The process then reiterates to step 204 where new data for a new experimental stage may be received.

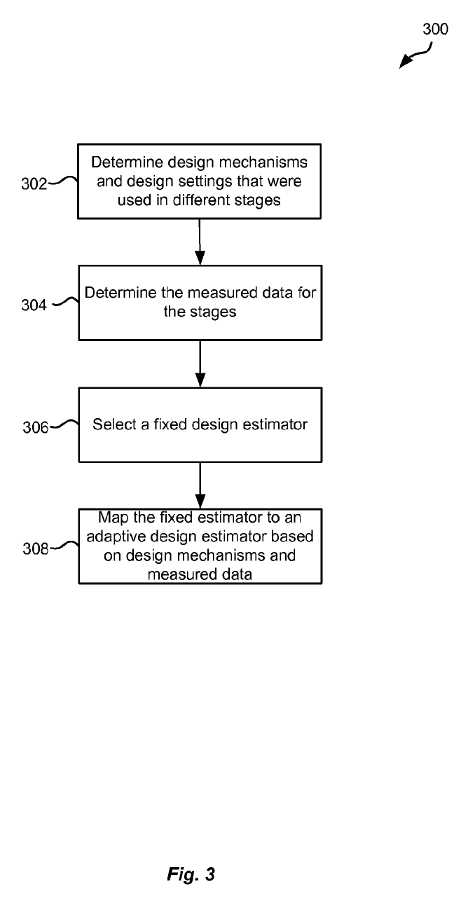

Once the stages of the experiment have been completed, an adaptive design estimator 102 of a particular target feature may be determined in step 214. FIG. 3 depicts a simplified flowchart 300 of a method for determining adaptive design estimator 102 according to one embodiment. In step 302, design settings and the design mechanisms that were used to generate these design settings for the stages are determined. For example, for each stage, the design settings and the design mechanism used in all experiments of that stage may be retrieved. Because the design settings were adapted during the experiment, the design mechanism that generated the observed design settings needs to be determined to determine the adaptive design estimator 102. This is different from a fixed design in which the design mechanism was not changed and thus adaptations to the design mechanism do not need to be taken into account when determining an estimator from the measured data.

In step 304, the measured data for the stages is determined. For example, the data may be determined from data storage 106.

In step 306, a fixed design estimator is determined. The fixed design estimator (as a mapping from data into the target feature, without evaluating it) that would have been appropriate for a fixed design sequence of experiments. Step 308 maps the fixed design estimator at a particular choice of fixed design mechanism into an adaptive design estimator 102 based on design mechanisms.

In mapping the fixed design estimator to the adaptive design estimator, weights may be selected and applied to the fixed design estimator function based on the design mechanisms and settings that were selected. In one embodiment a fixed design targeted maximum likelihood estimator is modified into an adaptive design targeted maximum likelihood estimator. Particular embodiments apply the fixed design targeted maximum likelihood estimator at a fixed design choice being a particular design mechanism such as the one used in the last experiment of the adaptive design sequence of experiments to be analyzed, but at each maximum likelihood estimation step the weighted maximum likelihood estimation is used instead, using the experimental unit specific weights described above in terms of the fixed design mechanism choice, the experiment specific design mechanism and the design settings used in that experiment.

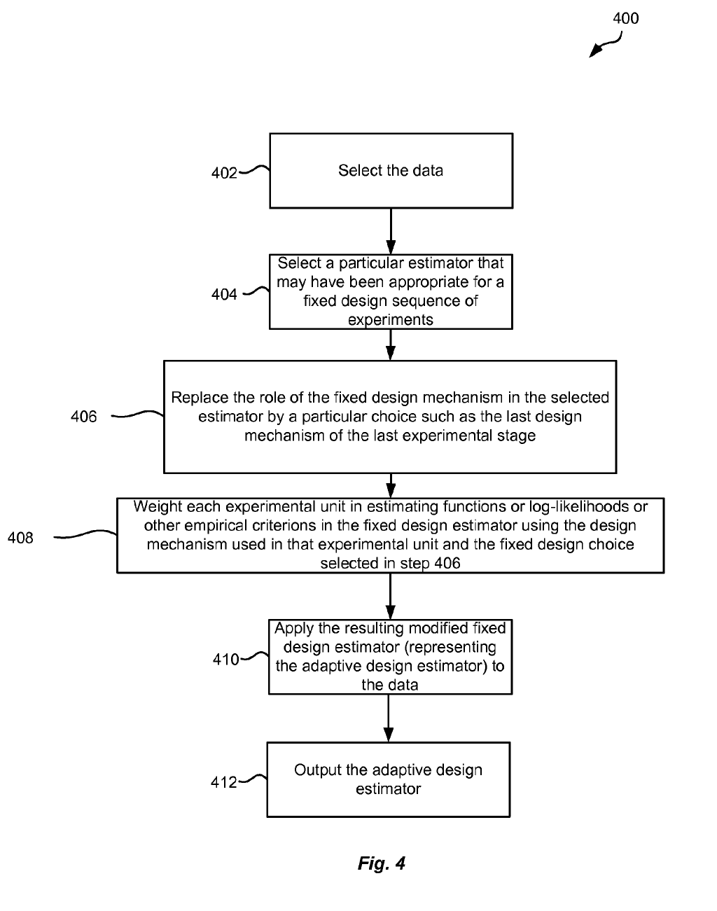

FIG. 4 depicts a simplified flowchart 400 of a method for obtaining an adaptive design estimator according to one embodiment. This method may be performed by computing system 100 or any other computing system programmed to execute the method.

Step 402 selects the data. The data is the data generated by the adaptive design.

Step 404 selects a particular estimator (as a mapping from data into the target feature, without evaluating it) that may have been appropriate for a fixed design sequence of experiments. This may be a fixed design estimating function based estimator or a fixed design targeted maximum likelihood estimator. Other estimators may be appreciated as well.

Step 406 replaces the role of the fixed design mechanism in the selected estimator by a particular choice such as the last design mechanism (i.e., the design setting estimator at last experiment) in the adaptive design sequence of experiments to be analyzed. Thus, computing system 100 may be modified to calculate the fixed design estimator by this substitution.

Step 408 weights the units in estimating functions or log-likelihoods or other empirical criterions in the fixed design estimator as described above for estimating functions. For example, using weights determined by the ratio of the design mechanism at the last experiment (as selected in step 406) and the unit specific design mechanism, where both conditional probabilities in numerator and denominator are evaluated at the observed design settings for that experiment. After this point, the mechanism that maps data into a fixed design estimator has been changed to a mechanism that maps data into an adaptive design estimator. This mapping represents the adaptive design estimator and this adaptive design estimator can be applied to data to be analyzed to obtain the estimate of the target feature.

Step 410 applies the resulting modified fixed design estimator (representing the adaptive design estimator) to the data. Step 412 then outputs the adaptive design estimator determined from applying the modified fixed design estimator to the data. The adaptive design estimator may then be used to estimate a target feature.

The unit specific weights defined as a fixed design divided by the actual adaptive design mechanism, as defined above, can be used to map an estimator of an expectation of a (e.g., loss) function of the unit specific data under fixed design sampling into a valid estimator of the same expectation but now under the actual adaptive design sampling. Specifically, an empirical average of a function of the data on each experimental unit is used, across a sequence of experimental units (e.g., empirical loglikelihood for candidate density estimator, empirical variance estimate, empirical MSE, empirical risk of prediction function), which is chosen to be a valid criterion under sampling from a fixed design. In some applications this function may be indexed by the fixed design mechanism or an estimate thereof. By weighting the function of each experimental unit by the unit specific weight defined in terms of this fixed design mechanism and the unit specific design mechanism actually used, the modified empirical criterion may now be used on the adaptive design data to estimate the same wished criterion. As a consequence, the weighting allows the mapping of empirical criteria for fixed design sampling into valid empirical criteria for adaptive design sampling.

In one embodiment, the variance of the efficient influence curve of the target feature at a candidate fixed design under fixed design sampling, representing how much information this candidate fixed design generates for the target feature, is estimated as the empirical weighted variance of the efficient influence curve at the candidate fixed design under adaptive design sampling. The design setting estimator (to be used as design mechanism in next stage of adaptive design) is now defined as the minimizer over a set of candidate fixed designs of this weighted criterion. Thus, the weighting allows learning of the optimal fixed design from previous data measured on previous stages of the adaptive design.

The process will now be described in more detail. In one embodiment, construction of targeted adaptive designs can be used to construct a large variety of adaptive designs such as adaptive clinical trials optimized with respect to treatment effects or optimal doses exploiting covariate information and dealing with common types of censoring. Although the adaptive designs may be discussed with respect to clinical trials, it will be understood that adaptive designs may be used with other designs.

The estimator may be a target maximum likelihood estimator but other estimators may be used. Targeted maximum likelihood estimation begins with the question of interest (the scientific parameter). By stating this parameter as narrowly as possible and orienting the statistical analysis around this specific question, bias may be reduced. The targeted maximum likelihood estimator builds upon (e.g.) a maximum likelihood estimator by mapping it into a new estimator of the data generating distribution that is optimized for efficient, unbiased estimation of the scientific parameter of interest.

Targeted maximum likelihood learning represents a statistical methodology for learning about a scientific parameter of interest. It bridges two often-competing camps in statistics, “The Bayesian/Maximum Likelihood” camp and the “Estimating Function/Efficient Influence Curve” camp, by providing a method that improves on each of these two general methodologies while retaining “log likelihood” as the principal basis of estimation.

Particular embodiments of targeted maximum likelihood learning are provided for data generated by (e.g., group sequential) adaptive designs. Although targeted maximum likelihood estimators are described, it will be understood other estimators may be used. Given an ordered sequence of experiments, particular embodiments predict design settings in the next set of experiments as a function of data collected in previous set of experiments. Such a design setting estimator can be used to set the design settings in next stages, and it can be adapted to learn an optimal design mechanism. Particular embodiments extend targeted maximum likelihood estimation based on data generated by identical and independently distributed experimental units to data generated by dependent experiments as described by adaptive design sequence of experiments. In addition, particular embodiments develop specific versions/embodiments of targeted maximum likelihood estimation referred to as Inverse Probability of Censoring Weighted-Reduced Data-Targeted Maximum Likelihood Learning.

A statistical framework to study adaptive designs and estimators based on data generated by these adaptive designs in great generality is provided. For each experiment a full data random variable is defined and, for the concrete development of methods and formal establishment of their validity it is assumed that across the sequence of experiments these random variables are identically and independently distributed. For example, the full data random variable is defined as the collection of setting-specific data structures that represents the data that would have been observed on a randomly sampled unit if these particular settings were applied in the design of this experiment, across all settings. The full data random variable is often defined as randomly drawing a unit from a population and measuring data on this unit under all possible design settings. Since a user often samples units from a well defined population, the assumption it is often reasonable to assume that these full data random variables are independent and commonly distributed. In addition, the observed data structure on an experimental unit is defined as a specified many to one mapping of a choice of design setting and the full data random variable, typically the data observed on a unit under the design settings actually selected, thereby missing all the data that would be observed under other design settings: This defines the observed data structure on each experiment as a censored/missing data structure on the full data.

The design settings (i.e., these can also be viewed as censoring/missingness variables) for experiment i are drawn from a conditional distribution, given the full data for the i-th unit, which satisfies the coarsening at random assumption for the i-th censored data experiment. The choice of the conditional distribution of the design settings for the i-th experiment can be fully informed by the observed data collected in the previous i-1 experiments, and any external data sources. The collection of these i-specific design mechanisms across the experiments are referred to as the adaptive design.

In the method for construction of targeted adaptive designs, optimized with respect to a user supplied target parameter of interest, and for the proposed embodiments of the targeted maximum likelihood estimators and estimating function based estimators, is the efficient influence curve or canonical gradient of a particular parameter of interest representing the scientific question of interest.

### Efficient Influence Curve:

A specified path-wise differentiable Euclidean (i.e., finite dimensional) parameter of the probability distribution of the data for a single experiment, which is well defined on the whole model, and which, for discussion purposes, is referred to as the scientific parameter. The probability distribution of the data for a single experiment is determined by the full data distribution (common to all experiments) and the design mechanism for that experiment. Given a class of paths/submodels through a probability distribution in the model, such a parameter's path-wise derivative at this probability distribution in the model for a single experiment (for a particular choice of fixed design) is identified by a well defined mathematical object, which is called the efficient influence curve. The efficient influence curve can be viewed as a transformation of the random variable that is observed on the experimental unit that captures all the relevant information of the random variable (drawn from the specific probability distribution) for the purpose of estimating the scientific parameter. The efficient influence curve is a transformation of the random variable that depends on the choice of probability distribution at which we take the path-wise derivative. In this manner, the efficient influence curve as a function of the data on a particular experimental unit is defined at each probability distribution (or corresponding density, as below) in the model or more specifically it is defined at a choice of full data distribution and design mechanism.

The first component is the method for construction of targeted adaptive designs, which will be discussed in further detail now. For discussion purposes, assume that the scientific parameter is univariate, i.e., is represented by a single number such as a causal effect of a treatment on the mean of a clinical outcome. The efficient influence curve is a function of a random variable generated by the experiment and its distribution is thus identified by the design mechanism (i.e., the distribution generating the design settings possibly in response to characteristics of experimental unit) and the full data distribution (representing the distribution common across all experiments) for that experiment.

Given a choice of full data distribution, the variance of the efficient influence curve as a function of the choice of design mechanism is considered by design setting estimator 104. Given a full data distribution, an optimal design is defined as the design mechanism that minimizes the variance of the efficient influence curve. This mapping from a full data distribution (or the part of this distribution needed to identify the efficient influence curve) to the optimal design is referred to as a design function, and the corresponding targeted adaptive design outputted by design setting estimator 104 is an immediate product of this design function by estimating it based on the data generated by the previous experiments and applying this estimated design mechanism to the current experiment. The targeted adaptive design aims to converge to this optimal design when the number of experiments converges to infinity.

In one embodiment, a targeted adaptive design is constructed as follows. Firstly, given the data generated by the first i-1 experiments, an estimate is obtained of the full data distribution or at least the part of the full data distribution the efficient influence curve depends upon, where this estimate may be based on a model. Secondly, given this estimate of the full data distribution, a corresponding estimate of the variance of the efficient influence curve as a function of a fixed design mechanism is obtained. The latter variance can be calculated analytically or estimated as a weighted empirical variance based on the first i-1 observations on the first i-1 experiments using the weighs described above for estimating functions in terms of the fixed design mechanism, and the experiment specific design mechanism of the adaptive design. Finally, for the i-th experiment the fixed design mechanism among a user supplied class of candidate fixed design mechanism optimizing this variance estimate is selected. This data adaptively selected fixed design is an adaptive design.

If the model for the full data distribution is correctly specified, this results in an adaptive design that converges to a stable choice of design mechanism equal to the optimal design minimizing the variance of the efficient influence curve so that the design which is optimal for the purpose of learning of the scientific parameter of interest may be determined. This same approach can be applied to any gradient (i.e. not necessarily the efficient influence curve also called the canonical gradient) by replacing the efficient influence curve/canonical gradient in the above description by this gradient, thereby resulting in targeted sub-optimal (but potentially much easier to implement in many applications) designs for the purpose of learning the scientific parameter of interest.

In the second component, the estimation of a scientific parameter based on data generated by an adaptive design such as a targeted adaptive design defined above will now be discussed. The estimating function methodology developed for identical and independent experiments, or, using other terminology, for fixed designs, can be used in for adaptive designs involving possibly different design mechanisms across a sequence of experiments (and which itself are functions of data generated by previous experiments).

In one embodiment, adaptive design estimator 102 uses an estimating function for a target feature developed for fixed (across n experiments) designs, which will often depend on the fixed design. Adaptive design estimator 102 either replaces the fixed design choice in this estimating function by the actually chosen i-specific adaptive design mechanism, or replaces this fixed design by a user-supplied choice of fixed design, and adaptive design estimator 102 weights the estimating function or components of the estimating function by the ratio of this selected fixed design to the true adaptive design, both evaluated at the observed design settings.

The resulting empirical average across the n experiments of the resulting estimating functions now represents a martingale sum so that consistency, and asymptotic normality for the solution of this martingale estimating equation in the parameter of interest (i.e., target feature) is achieved under appropriate regularity conditions (e.g. standard smoothness) on the estimating function. As a consequence, properties of the fixed design estimating function are inherited for the corresponding adaptive design estimating function. In addition, adaptive design estimator 102 provides estimators of the parameter of interest that are double robust with respect to misspecification of the true design for experiment i and the full data distribution component the estimating function depends upon, so that in adaptive designs in which the design mechanism choices are known the estimators defined as solutions of these martingale estimating equations are always consistent and asymptotically normally distributed even if the chosen working models for the full data distribution are mis-specified.

Particular embodiments provide a particular mapping from an initial density estimator into a new density estimator, which is referred to as a one-step targeted maximum likelihood (density) estimator, where the word “targeted” refers to targeted towards the scientific parameter. Adaptive design estimator 102 calculates the one-step targeted maximum likelihood estimator of the data generating density by maximizing a weighted log-likelihood of the n observations on the n random variables over a parametric fluctuation of the initial density estimator treating the initial density estimator as given, where this parametric fluctuation is indexed by a parameter named as epsilon. This fluctuation indexed by parameter epsilon is chosen to satisfy the condition that it crosses the initial density estimator at epsilon value 0 and the linear span of the components of the score-vector (i.e., the derivative at epsilon value zero of the log of the parametric fluctuation of the initial density estimator) of the parametric fluctuation at epsilon value 0 includes the so called efficient influence curve (of the scientific parameter) defined by the initial density estimator and some user supplied fixed design distribution. In addition, the weight for observation i is set equal to the ratio of this user supplied fixed design distribution and the true design distribution for experiment i, as above.

The scientific parameter value of the k-th step (k>=1) targeted maximum likelihood estimator has significantly less bias than the scientific parameter value of the initial density estimator. In particular, in the class of censored and causal inference models, particular embodiments have a double robustness property the initial maximum likelihood estimator lacks. Therefore, this mapping of an initial density estimator into the corresponding k-th step targeted maximum likelihood density estimator can be a bias reduction method with respect to the scientific parameter.

Particular embodiments provide this novel k-th step targeted maximum likelihood estimator based on data generated by sequential adaptive designs, and provides corresponding statistical inference (e.g., confidence intervals and tests for the scientific parameter based on the targeted maximum likelihood estimator).

Another embodiment of targeted maximum likelihood learning applies this same iterative targeted MLE to a reduced data structure using the same weights which is called Inverse Probability of Censoring Weighted-Reduced Data-Targeted Maximum Likelihood Estimator (IPCW-R-TMLE). IPCW-R-TMLE represents a general class of targeted maximum likelihood estimators including the one mentioned above based on the complete data set. Natural variations of this iterative IPCW-R-TMLE such as corresponding one-step targeted maximum likelihood estimators are provided as well.

The desired value of epsilon of the parametric fluctuation is obtained by maximizing the log-likelihood along the parametric fluctuation over epsilon. In this variation, the desired value of epsilon is set equal to the solution of an equation defined by setting zero equal to the empirical mean of the weighted efficient influence curve defined by the parametric fluctuation in epsilon of the initial density estimator and a fixed design. This one-step targeted estimator enjoys the same theoretical properties (consistency, asymptotic linearity, asymptotic normality and local efficiency) as established for the k-th step targeted maximum likelihood estimator.

The estimating function based methodology for adaptive designs, and the targeted MLE for adaptive designs is more robust (i.e., less biased) than maximum likelihood estimation for adaptive designs. In addition, targeted MLE has additional benefits relative to estimating function based methodology, although both methods may have similar asymptotic behavior for large sample sizes

In another embodiment, a targeted empirical Bayesian methodology allows incorporation of a prior distribution on the scientific parameter of interest and maps it into a valid robust and targeted posterior distribution for the parameter of interest, by preserving the frequentist properties of the (iterative) targeted MLE. It is taking one of the iterative targeted MLE and the optimal fluctuation function through it as model with only parameter being the fluctuation parameter, and subsequently it applies standard Bayesian inference by calculating the posterior distribution of epsilon given the data, treating the targeted ML density estimator as fixed. This targeted empirical Bayesian methodology is presented for adaptive group sequential designs.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for targeted adaptive design processing, the method comprising:
determining data for a first stage of an adaptive design, each stage of the adaptive design being a set of experiments that are performed based on a design mechanism, the data for a stage including data for the set of experiments for that stage;
determining an estimator based on the data for the first stage; and
analyzing the data using the estimator to adapt the design mechanism for a next stage of the adaptive design, the adaptive design mechanism being considered more optimal to yield data for estimating a target parameter; and
outputting the design mechanism for use in a second stage of the experiment.

2. The method of claim 1, wherein the estimator comprises a targeted maximum likelihood estimator based on the data.

3. The method of claim 2, wherein the estimator estimates an unknown optimal fixed design by adapting the design mechanism.

4. The method of claim 1, wherein the design mechanism comprises a probability distribution that can be used to generate design settings for an experimental unit in the second stage of the experiment.

5. The method of claim 4, wherein the probability distribution is used in randomizing the second stage of the experiment.

6. The method of claim 1, further comprising changing the design mechanism for generating settings for a next stage of the adaptive design based on the estimator.

7. The method of claim 1, further comprising:
analyzing the data for a plurality of stages including the first stage and second stage with different sets of design mechanisms and the data measured for the plurality of stages for the experiment; and
determining a second estimator for the adaptive design usable to estimate the target parameter of the adaptive design based on the analysis.

8. The method of claim 7, wherein determining the second estimator comprises:
determining design mechanisms for the plurality of stages of the adaptive designs; and
adjusting the second estimator based on the design mechanisms determined.

9. The method of claim 8, wherein adjusting comprises inverse weighting the second estimator based on a probability distribution of the design settings of experimental units in the stages of the experiment.

10. The method of claim 8, wherein the inverse weighting is used to map an empirical criterion under a fixed design sampling into an empirical criterion under an adaptive design sampling using adaptive design mechanisms.

11. The method of claim 7, wherein determining a second estimator comprising:
determining a fixed design estimator configured to estimate under fixed design sampling; and
mapping the fixed design estimator into the second estimator based on the design mechanisms used in the plurality of stages of the experiment, wherein the second estimator estimates the target parameter based on adapting of the design mechanism.

12. The method of claim 11, wherein the mapping comprises:
determining a fixed design estimator configured to estimate under fixed design sampling;
replacing a role of the fixed design in the fixed design estimator by an estimate of a fixed design mechanism based on the data;
weighting each experimental unit in the plurality of stages by a ratio in which a numerator is determined by fixed design mechanism and the denominator is determined by the design mechanism of the experimental unit.

13. The method of claim 7, wherein the second estimator comprises an empirical Bayesian targeted maximum likelihood estimator or a martingale estimating equation based estimator.

14. The method of claim 1, further comprising receiving a set of data for the first stage and second stage of the experiment usable to estimate the target parameter of adaptive design, the first stage using a first design mechanism and the second stage using a second design mechanism.

15. The method of claim 1, wherein the estimator is determined by evaluating an estimate of variance of an influence curve based on a fixed design among a class of candidate fixed designs.

16. An apparatus comprising:
one or more processors; and
logic encoded in one or more tangible media for execution by the one or more processors and when executed operable to:
determine data for a first stage of an adaptive design, each stage of the adaptive design being a set of experiments that are performed based on a design mechanism, the data for a stage including data for the set of experiments for that stage;
determine an estimator based on the data for the first stage; and
analyze the data using the estimator to adapt the design mechanism for a next stage of the adaptive design, the adaptive design mechanism being considered more optimal to yield data for estimating a target parameter; and
output the design mechanism for use in a second stage of the experiment.

17. The apparatus of claim 16, wherein the design mechanism comprises a probability distribution that can be used to generate design settings for an experimental unit in the second stage of the experiment.

18. The apparatus of claim 16, further comprising:
analyzing the data for a plurality of stages including the first stage and second stage with different sets of design mechanisms and the data measured for the plurality of stages for the experiment; and
determining a second estimator for the adaptive design usable to estimate the target parameter of the adaptive design based on the analysis.

19. The apparatus of claim 18, wherein determining the second estimator comprises:
determining design mechanisms for the plurality of stages of the adaptive designs; and
adjusting the second estimator based on the design mechanisms determined.

20. An apparatus configured comprising:
means for adaptive design being a set of experiments that are performed based on a design mechanism, the data for a stage including data for the set of experiments for that stage;
means for determining an estimator based on the data for the first stage; and
means for analyzing the data using the estimator to adapt the design mechanism for a next stage of the adaptive design, the adaptive design mechanism being considered more optimal to yield data for estimating a target parameter; and
means for outputting the design mechanism for use in a second stage of the experiment.
